(19) United States
(12) Patent Application Publication
(10) Pub. No.: US 2006/0252017 A1
(43) Pub. Date: Nov. 9, 2006

(54) Definition of dynamic movement parameters of a material object during sports competitions or trainingc

(76) Inventors: Georgy Nikolaevich Vorozhtsov, Moscow (RU); Viktor Borisovich Loschenov, Moscow (RU); Evgeny Pavlovich Khiznhnyak, Mikroraion (RU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/540,948

(22) PCT Filed: Dec. 25, 2003
(86) PCT No.: PCT/RU03/00586

§ 371 Date: Jun. 1, 2006

(30) Foreign Application Priority Data
Dec. 26, 2002 (RU) 2002135045

(51) Int. Cl. A63B 69/00; G09B 19/00; G09B 9/00

(52) U.S. Cl. 434/247

(57) ABSTRACT

The invention is directed at the definition of the dynamic movement parameters of a material object during sports competitions or training and makes it possible to improve a judgment objectivity during said sports competitions. A footmark trajectory resulting from the interaction of am object with surrounding objects or environment is recorded in an infrared spectral range. The dynamic of modifications of infrared footmarks in different spectral ranges are recorded. The trajectories of shadows formed by external infrared sources are recorded. The inventive device system comprises an infrared camera, a computer and a mechanical oscillation receiver. Said infrared camera can be provided with a system of optical filters for modifying the spectral range of the sensitivity thereof.

### FIELD OF THE INVENTION

The invention relates to monitoring techniques that are needed both in sports competitions and training. More particularly, the invention relates to determining dynamic movement parameters of a material object during competitions and training.

“Material object” refers to an object moving in space, such as a ball (tennis, ping-pong, football, volleyball, etc.) and sporting tools such as racket, javelin, hammer, discus; in winter sports—skates, skis, sledges, etc, that contact surrounding objects, environment or other sporting equipment.

In addition, a material object may be a sportsman himself or his clothes moving relative to a surrounding medium (swimmer's or water jumper's skin and diving suit relative to water, a runner relative to air, jumper's shoes relative to sport field, etc.).

### BACKGROUND OF THE INVENTION

According to prior art determination of dynamic parameters of an object in sports competitions or training by optical devices and cameras that operate in visible range is insufficiently solved and fails to satisfy the existing need. By way of example, estimation of the ball flight velocity provides just a single parameter from many needed ones. Slow video filming fails to provide an accuracy required to objectively determine the out condition.

WO 87/01295, A63B71/06, discloses a method of providing an image of the position of tennis ball hit on the court by means of infrared cameras, comprising the steps of recording the ball position during the contact and two ball positions after the contact, in order to identify whether the footmark belongs to the rebound ball or not, without confusing with other heat footmarks. The method fails however to provide information of all components of the ball motion; it rather determines the position of the ball contact with the court surface only at insufficient level of accuracy.

EP 0812228, A63B71/06, published on 2000 discloses a method of determining the contact area of an object used in sport (ball, player, tire, runner, etc.) and a base (ground, table surface, boundary of the field, etc.), involving the use of additional metal powder marking on the ground in order to emphasize the distinction between the restrictive stripes and the ground itself and thereby improve the accuracy of locating the sporting object by infrared footmark. A disadvantage of the method is that it determines only the contact area, so only the parameters of the object that characterize its motion during the contact only can be determined. In this case such movement parameters as movement energy, linear and rotation speed of the object are not evaluated. Furthermore, merely the heat printout resulting from the ball rebound from the court surface is insufficient for a referee because one and the same strike can have different footmark length depending on the infrared camera sensitivity. And vice versa, at the same camera sensitivity, different strike velocity and different court covering could also result in different footmark lengths, this hampering the judging whether the out condition has taken place or not. Furthermore, to implement this method a special paint must be used to emphasize contrasting of the court boundaries in an infrared range. All these circumstances impose substantial limitations on the method use.

Therefore, the object of the present invention is to provide a method for defining dynamic movement parameters of a material object, which would enable obtaining a sufficient number of qualitative dynamic parameters to improve the objectivity of judging during sports games, and assist engineers, designers and scientists in development and improvement of sporting equipment, as well as provide assistance in the training process.

### SUMMARY

The object is attained in a method for determining dynamic parameters of a material object in sports competitions or training, comprising: recording the trajectory of object movement in an infrared spectral range; recording trajectories of infrared footmarks resulting from the interaction of the object with surrounding objects or surrounding environment.

“Infrared footmark” refers to a part or entire surface of an object (ball, court, medium) having a temperature differing from that of the environment or other parts of the object. Infrared footmark may have a positive value if it results from inelastic impingement of two objects. In this case the temperature of the contact area is higher than that of surrounding bodies or parts of the object. Infrared footmark may have a negative value if it shades the other warmer objects or is located in the environment having a temperature higher than that of the object.

“Infrared footmark trajectory” refers to a geometric place of points produced by motion of an infrared footmark in air medium and on the surface of another object. At the same time, infrared footmark may have a positive or negative value relative to the medium and on the surface.

There will be several infrared footmark trajectories during the flight of the ball from one player to the other one. Depending on the task set, one, two or more trajectories may be analyzed simultaneously.

The footmarks may be e.g. footmarks resulting from the contact of a ball with the court surface. Footmarks can also result from shading the heat radiation emitted or reflected by surrounding objects (court surface, spectators and other heat sources) by the ball.

To obtain more correct dynamic movement parameters of a material object, the method further comprises recording the dynamic of modifications of infrared radiation intensity on different parts of the trajectory of the object motion; recording infrared footmark trajectories in different spectral ranges, or further recording trajectories of shadows resulting from the interaction of the object with concentrated or distributed external infrared sources.

Furthermore, in big tennis the contact area of the ball with the court and the instant of impingement of the ball with the court surface are recorded using the fracture of infrared footmark trajectories. Shapes of trajectories can be also used to determine parameters important for evaluating the strike quality, such as the ball linear speed, rotation speed and the change of the ball flying-away angle as compared to the ball flying-up angle.

WO 87/01295 discloses a system of devices for objectively judging tennis competitions, comprising one or more infrared cameras and a computer connected to peripheral devices. The system, however, fails to provide a sufficient number of dynamic parameters of the ball movement at sufficient level of accuracy.

The object of the invention is to provide a system of devices, which would enable determining the required dynamic movement parameters of material objects in sports competitions or training at a sufficient level of accuracy.

The object is attained in a system of devices, comprising one or more infrared cameras and a computer, and further comprising a mechanical oscillation receiver.

The system can further comprise an external light source.

To improve accuracy of the obtained dynamic parameters, the light source is preferably modulated by frequency or infrared wavelengths and synchronized with the one or more infrared cameras.

Additionally, the infrared cameras can have a controlled time of registration of image.

The one or more infrared cameras can comprise an appliance to enable the movement synchronized with the mechanical oscillation receiver.

The one or more infrared cameras can comprise a system of optical filters to modify the spectral range of sensitivity of the infrared camera.

### DETAILED DESCRIPTION OF DRAWINGS

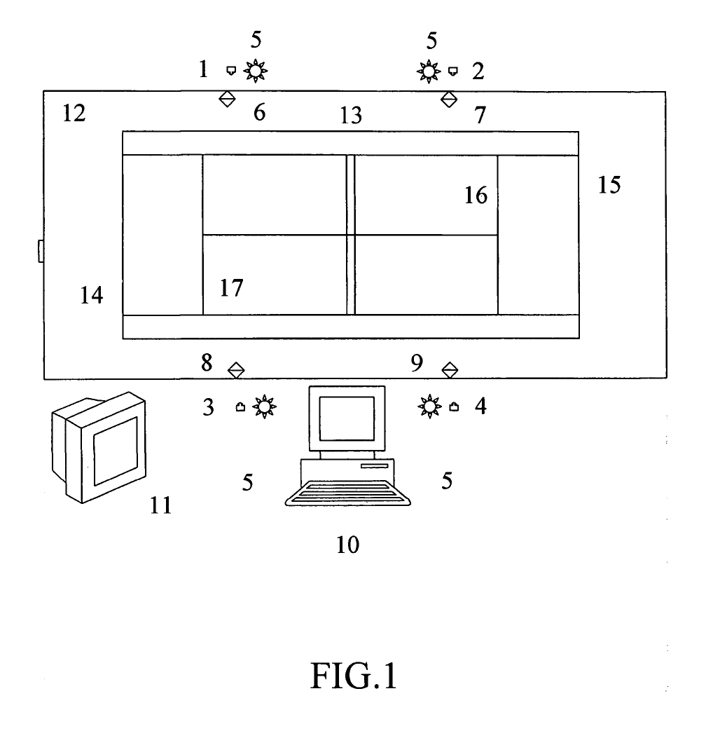

FIG. 1 shows a schematic diagram of a system of devices, e.g. for tennis (in case of other games, the number and mutual arrangement of cameras, infrared light sources and mechanical oscillation receivers can be different. By way of example, for table tennis and billiard all of the three devices, in single instance, are arranged under the table), which system comprising:

infrared cameras 1,2,3,4 having a rotation mechanism synchronized with mechanical oscillation receivers and a system of optical filters;

four infrared light sources 5 synchronized with infrared cameras;

mechanical oscillation receivers 6,7,8,9 for synchronous reception of mechanical oscillations through air and over the court covering, the receivers being connected to a mechanical oscillation analyzer which provides signals to open and close infrared cameras;

a central computer 10 with control boards and a software to provide coordinated operation of the infrared cameras, mechanical oscillation receivers and modulation of the infrared light sources;

a video display 11 for demonstrating to spectators the results of processing the infrared footmark trajectories as images and numerical values of ball movement parameters during the game;

a tennis court 12;

a net 13;

a first player's serving point 14;

a second player's serving point 15;

a point 16 of ball contact with the court after the first player's serve;

a point 17 of ball contact with the court after the second player's serve.

The system of devices in accordance with the invention operates as follows.

When the ball is served from the left position 14, sound from the racket striking the ball reaches receivers 6 and 8 which open cameras 2 and 4 and close cameras 1 and 3. During the time of signal passage from the racket to the receivers, the ball will fly for about two meters maximum, which distance does not affect the accuracy of footmark trajectory construction, hence, the determination of ball movement parameters. When the ball touches a point 16, the resulting mechanical oscillation is transmitted through the court covering (or air) to receivers 7 and 8 which close cameras 2 and 4 after a predetermined time, e.g. 1 sec. When the ball is received by the second player, sound from the racket striking the ball is detected by the receivers 7 and 9 which open cameras 1 and 3 and close the cameras 2 and 4 if they have not been yet closed by the previous signal. The infrared light source 5 operates synchronously either with frame-by-frame scanning or with mechanical oscillation receivers. When the second player serves the ball, the devices interact in the same fashion. The scheme with mechanical oscillation receivers is employed in order to reduce the data processing volume and accelerate outputting on referee's and spectators' video displays the frames illustrating the contact of the ball with the court and parameters of the ball flight velocity, including the number of ball revolutions. The infrared light is used to emphasize the court marking contrast, if necessary, and to create a shadow from the flying ball to be used in constructing or specifying the infrared footmark or ball movement trajectory. This ensures more accurate definition of the position of ball contact with the court. The necessity of using several devices is caused by the fact that the sportsman or parasitic acoustic signals can shield the ball trajectory. Nevertheless, the objects of the invention described in the preamble can be attained using a single system or even a single camera.

Examples presented below illustrate how a method according to the invention can be implemented using the suggested system of devices.

### EXAMPLE 1

Determination of some movement parameters of a tennis ball, including the out condition, using recording infrared footmark trajectories and shadows during sports competitions by infrared cameras operating in long-wave spectral range.

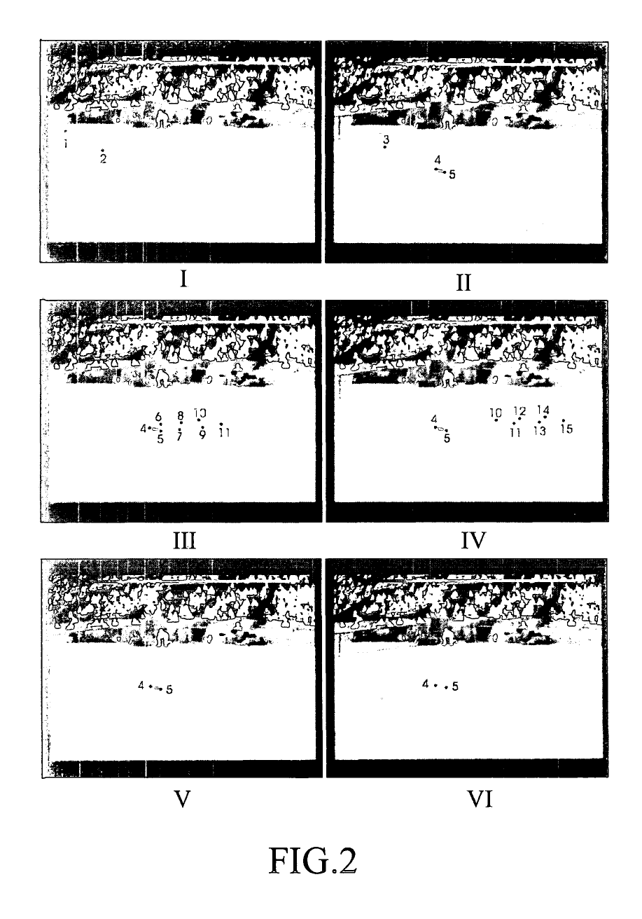

FIG. 2 shows six successive frames of infrared images of a single tennis game episode. Duration of each frame for the used camera was τ=4·10⁻² sec.

Each successive frame “remembers” the end part of the preceding frame, thus allowing reconstruction of the image in continuous fashion.

In frame I, a trajectory of the shadow created by the ball (the ball temperature is smaller that that of the court surface) is seen as a straight line between points 1 and 2. The ball flight velocity is V=S(1÷2)/τ, where

S(1÷2) is the distance between points 1 and 2=2.3 meters;
=4·10⁻² s;
V=2.3 m/4·10⁻² s=57.5 m/s=207 km/hour.

Frame II shows continuation of the movement trajectory of the shadow produced by the ball, S(3÷4)=2.3 m, and the trajectory of infrared footmark, S(4÷5), resulting from the friction between the ball and the court when the ball touches the court. S(4÷5)=15 cm.

If geometrical dimensions of the 1-2-3-4 trajectory coincide with those of the ball trajectory (in this particular case), the footmark trajectory on the court surface will have geometrical dimensions depending on the ball rotation speed and linear speed. Light intensity of the footmark trajectory depends on the above parameters as well. This will be true for a particular court covering and ball quality.

In frame III, continuation of the infrared footmark trajectory, S(6÷7), S(8÷9), S(10÷11) and the remaining infrared footmark on the court surface, S(4÷5), are recorded.

The infrared footmark trajectory is intermittent due to revolution of the ball about its axis. The ball rebound speed and the number of revolutions (n) can be readily calculated.
V (rebound)=2.0 m/4·10⁻² s=50 m/s=180 km/hour.

With the frame duration of 4·10⁻² s , and in view of the fact that the ball has made two full revolutions and half revolution more as minimum, as seen in the shot, n(6÷11)=2.5 rev/4·10⁻²s=60 rev/s=3600 rev/min.

Frame IV shows continuation of the trajectory of infrared footmark corresponding to ball movement trajectory S(12÷13), S(14÷15), and the remaining infrared footmark on the court surface, S(4÷5), as well as a part of the trajectory S(10÷11) that has remained from the previous frame.

The ball flight velocity after rebound, V(12÷15)=1.5 m/4·10⁻² s =37 m/s=133 km/hour.
n(12÷15)=1.5 rev/4·10⁻² s =37 rev/s=2200 rev/min.

Thus, the ball flight velocity and the number of revolutions about the ball axis decrease rather fast after the ball striking the court.

In frame V only the footmark trajectory S(4÷5) is visible, which has generally disappeared in frame IV. However, while the preceding five frames were taken successively one after another, 40 frames were omitted between the fifth and sixth frames. Therefore, the time of disappearance of the infrared footmark left on the court by the ball in the game episode was τ=4·10⁻² s=1.6 sec of the footmark.

It is interesting to note that in the above game episode that took place in Kremlin Cup 2002, the ball missed the “field”. This is clearly seen in the infrared footmark part S(3÷4÷5).

The above registration results of the movement trajectory will be used to determine movement parameters of the tennis ball in the interval between the racket strike and the second contact of the ball with the competitor's racket or the court surface. Unknown parameter is the ball rotation speed (number of revolutions) during the strike. The ball rotation speed can be analytically determined from the energy conservation equation:
Eₚ+Eₖ+Eₖᵣ=E′ₚ+E′ₖ+E′ₖᵣ+A_{fr},

where

Eₚ, E′ₚ is the potential energy of the ball before and after the first contact with the court, respectively;

Eₖ, E′ₖ is the kinetic energy of movement of the ball having mass m with velocity v before contact with the court and velocity v′ after contact with the court, respectively;

Aₜₚ is the energy spent to overcome the friction force appearing when the ball touches the court.

To facilitate the solution, the energy spent for air drag will be neglected in this example.

In the above example the ball revolution speed or, more commonly, the number of ball revolutions about its axis, n=70 rev/s=4200 rev/min.

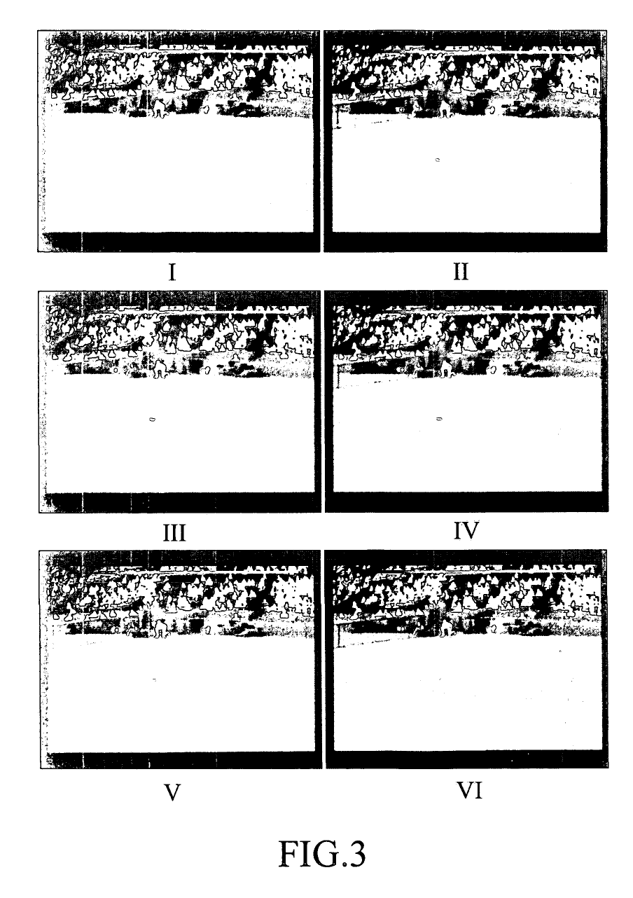

FIG. 3 shows the same frames as in FIG. 2, but without inventor's markings.

### EXAMPLE 2

Determination of the ball flight velocity and the contact area of the ball with the court, using a video camera operating in the near infrared range.

The use of a video camera operating in the near infrared range provides the possibility of using infrared light sources which are invisible to human's eye and therefore do not interfere with viewing the competition by spectators.

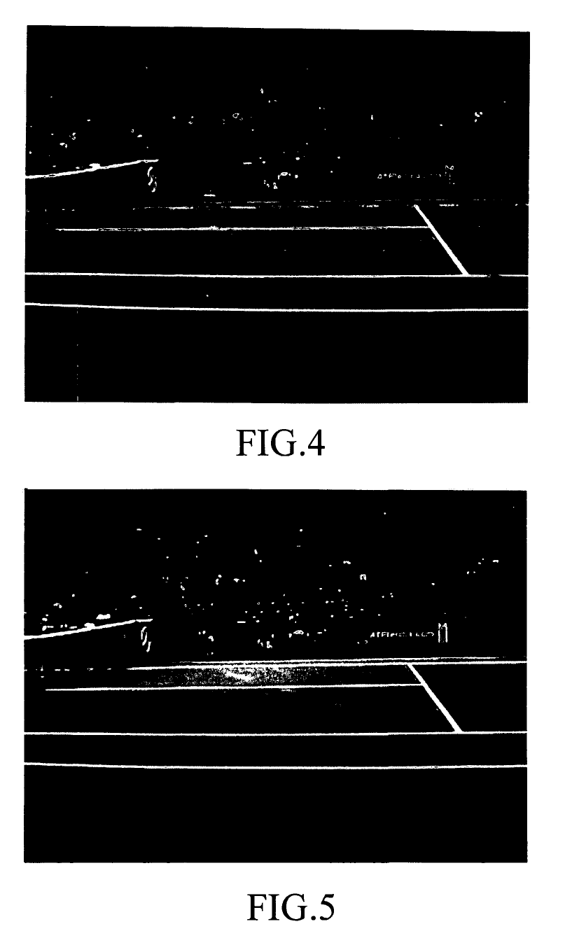

FIGS. 4 and 5 show the shots (frames) wherein the ball flight trajectory and the ball shadow trajectory have been recorded by the camera operating in the mode: 20 ms open, 20 ms closed. The camera operated in the near infrared range without an infrared highlight (that is why the trajectory of shadow created by the ball is poorly seen). Analysis of the trajectories makes it possible to easily compute the ball flight velocity (in this case it is 38 m/s) and specify the position of the ball contact with the court by the break point of the trajectory curve. For more accurate analysis of the contact area of the ball with the court, two trajectories are to be analyzed: the trajectory created by the trace of light reflected from the ball, and the trajectory created by a shadow appearing when the ball shields the light flow produced by the infrared source.

Skill and development potential of sportsmen can be evaluated using dynamic movement parameters of the tennis ball, such as linear speed and acceleration, ball rotation speed, and the change in spatial flying-off angle versus flying-up angle of the ball, which can be determined by the methods described in Examples 1 and 2. An integral parameter of skill and development potential of sportsmen may be a sporting skill factor which can be computed as an integral factor taking into account the role of each of the listed above dynamic parameters with appropriate weights.

Consequently, a method and a system of devices for implementing the method in accordance with the invention allow determination of a number of dynamic movement parameters of a material object in sports competitions or training, this enabling more strict documentation of all sporting event steps and demonstrating them to referees and spectators, and more objective evaluation of sportsmen skill, as well as providing assistance to engineers and scientists in development and improvement of sporting equipment.

### EXAMPLE 3

Estimation of uniformity of the load on skier's legs during training, and evaluation of ski wax quality.

Measurements were taken by an infrared camera in 8-12 μm range. The camera was opened and closed by the acoustic signal produced by the contact of the ski with snow and received by a detector. The image was processed by special software enabling numerical calculation of ski-to-snow adhesion parameters obtained from infrared trajectories.

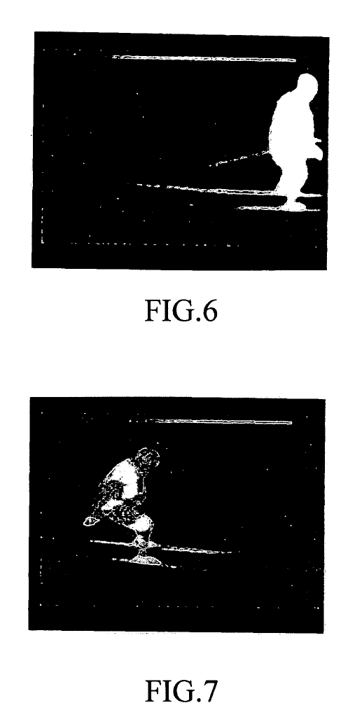

FIG. 6 shows a skier's footmark trajectory during training. The same wax was applied on both skis. Different intensity of the two white discontinuous strips evidences that the load on the legs was non-uniform. In this case the load on left leg was about two times that on the right leg.

FIG. 7 shows an infrared image of a skier moving on the skies covered with different waxes. Applied on the right ski was a wax intended for a temperature from −10° C. to −15° C., while the left ski was covered with a wax for 0° C. The ambient temperature was minus 5° C. As seen in the drawing, image of the left ski is brighter than that of the right one. Hence friction of the left ski against snow was greater than that of the right ski. Consequently, the wax for temperature from −10° C. to −15° C. was more suitable in this case.

### EXAMPLE 4

Estimation of the effect of load distribution inside a sports car on its movement parameters during training on the basis of infrared footmark trajectory.

Measurements were taken by an infrared camera in 8-12 μm range. The camera was operated by acoustic signals produced when the car tire contacted the road surface and detected by a detector. The image was processed by special software enabling calculation of the tire-to-road surface adhesion, load uniformity and other parameters obtained on the basis of infrared trajectories.

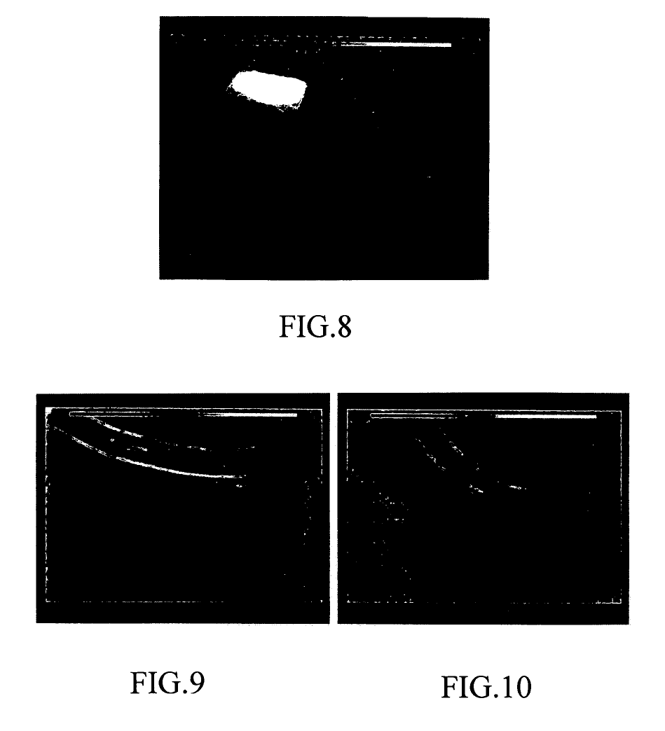

FIG. 8 shows a trajectory of the infrared footmark of a car that has started the movement. The trajectory comprises two strips. Beginnings of the strips, associated with the car start, are of different intensity. The left trajectory beginning is more intense than the right one. This evidences a nonuniform load distribution inside the car and the weight tilt to the left.

FIGS. 9 and 10 show trajectories of infrared footmarks produced by a car moving along a curve. (The car moved from the right to the left at the same speed in both cases). FIG. 9 shows the infrared footmark trajectory of a car with incorrectly distributed load. As seen, at the steep portion of the bend the rear wheels of the car were skidded to the left. FIG. 10 shows an infrared footmark trajectory with optimized load distribution. As seen, the trajectory comprises uniform strips with smoothly varying intensity.

### EXAMPLE 5

Energy losses of swimmers in diving suits and without them.

Measurements were taken by an infrared camera in 8-12 μm range. The camera was operated by an acoustic wave appearing when a sportsman touched water surface and detected by a detector. The image was processed by special software allowing numerical calculation of heat losses.

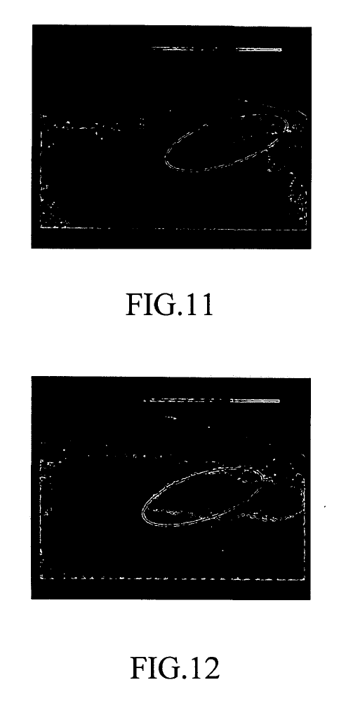

A swimmer pushed away from the swimming pool edge and swam under water for some time. In FIG. 11 the swimmer was in a diving suit, and the heat footmark are hardly seen. In FIG. 12 the swimmer had no diving suit. Intense infrared footmark and its trajectory are visible. Heat losses of the sportsman without a diving suit were essentially higher.

### EXAMPLE 6

Assessment of surface quality of a moving sporting tool.

Measurements were taken by an infrared camera in 8-12 μm range. The camera was operated according to variation in the acoustic spectrum sensed by a detector, caused by modification in the turbulence level. The image was processed by special software enabling numerical calculation of required movement parameters of the objects from the obtained infrared trajectories.

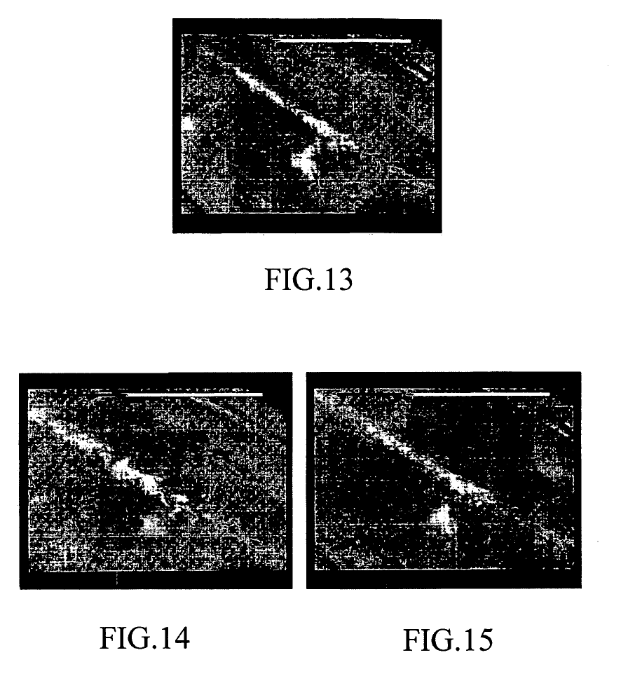

The manner of interaction of a moving sporting tool with air or water medium defines its velocity and accuracy of hitting the target. In first approximation, the interaction manner is defined by the relation of laminar and turbulent components of the flow, or the footmark left by the moving tool. FIG. 13 shows a trajectory of infrared footmark of a solid object (simulating a sporting tool such as javelin, bullet, water skis, bottom of a ship, etc.) that moves in water with some velocity. FIG. 14 shows a trajectory of the same object moving with a greater velocity. As seen, the turbulence component increased substantially. FIG. 15 shows an infrared footmark trajectory of the same object with the same velocity as in the second case, but having a surface coated with a water-repellent composition. As seen, the turbulence component is reduced to the original level.

1. A method for determining dynamic movement parameters of a material object in sports competitions or training, using recording the object motion trajectory in an infrared spectral range, characterized by recording trajectories of infrared footmarks resulting from the interaction of the object with surrounding objects or surrounding environment; recording and analyzing the dynamic of changes of infrared radiation intensity on different parts of the trajectory of the object motion and calculating the object movement parameters therefrom.

2. The method according to claim 1, characterized by further recording trajectories of infrared footmarks in different spectral ranges.

3. The method according to claim 1, characterized by further recording trajectories of shadows resulting from the interaction of the object with concentrated or distributed external infrared sources.

4. The method according to claim 1, characterized in that in big tennis the area of the ball contact with the court and the time moment of the ball impingement with the court surface are determined using the break of trajectories of infrared footmarks.

5. An apparatus for determining dynamic movement parameters of a material object in sports competitions or training, comprising at least one infrared camera and a computer, characterized by further comprising a mechanical oscillation receiver connected to the infrared camera.

6. The apparatus according to claim 5, characterized by further comprising an external light source.

7. The apparatus according to claim 5, characterized in that the external light source is modulated by frequency or infrared radiation wavelengths and is synchronized with the infrared cameras.

8. The apparatus according to claim 5, characterized in that the infrared cameras have a controlled time of fixing image.

9. The apparatus according to claim 5, characterized in that at least one infrared camera comprises an appliance enabling its rotation and movement synchronized with the mechanical oscillation receiver.

10. The apparatus according to claim 5, characterized in that at least one infrared camera comprises a system of optical filters for modifying the spectral range of sensitivity of the infrared camera.

11. A method of evaluating skill and development potential of sportsmen, comprising using a method for determining dynamic movement parameters of a material object in snorts competitions or training, using recording the object motion trajectory in an infrared spectral range, characterized by recording trajectories of infrared footmarks resulting from the interaction of the object with surrounding objects or surrounding environment; recording and analyzing the dynamic of changes of infrared radiation intensity on different parts of the trajectory of the object motion and calculating the object movement parameters therefrom and the apparatus as set forth in claim 5.
